(19) United States
(12) Patent Application Publication
(10) Pub. No.: US 2025/0076881 A1
(43) Pub. Date: Mar. 6, 2025

(54) PREPOSITIONING AND DYNAMIC DISTRIBUTION OF ROADSIDE ASSISTANCE VEHICLES IN AN AUTONOMOUS VEHICLE SERVICE

(71) Applicant: Waymo LLC, Mountain View, CA (US)

(72) Inventors: Son-Ca Nguyen, Mountain View, CA (US); Ganesh Balachandran, Mountain View, CA (US); Renaud-Roland Hubert, Gilroy, CA (US); Victor Chan, Mountain View, CA (US); Celia Zhang, Sunnyvale, CA (US); Steven Kleiser, Mountain View, CA (US); Kai Ying, Dublin, CA (US); Kerry Chen, San Jose, CA (US); Alfred Wang, South San Francisco, CA (US)

(21) Appl. No.: 18/459,537

(22) Filed: Sep. 1, 2023

(51) Int. Cl. G05D 1/02

(52) U.S. Cl. CPC G05D 1/0291

(57) ABSTRACT

Aspects of the disclosure provide for enabling distribution or prepositioning of roadside assistance vehicles within a service area for a fleet of autonomous vehicles. For instance, a clustering approach may be used to determine an assignment identifying a plurality of cluster locations and respective assigned ones of the roadside assistance vehicles. The clustering approach uses a number of clusters corresponding to the number of the roadside assistance vehicles. Distribution information may be sent to computing devices associated with technicians of the respective assigned ones of the roadside assistance vehicles. The distribution information may enable the technicians of the respective assigned ones of the roadside assistance vehicles to proceed to the cluster locations of the determined assignment.

### BACKGROUND

Autonomous vehicles for instance, vehicles that may not require a human driver, can be used to aid in the transport of passengers or goods from one location to another. Such vehicles may operate in a fully autonomous mode where passengers may provide some initial input, such as a pickup or destination location, and the autonomous vehicle maneuvers itself to that location. Autonomous vehicles are equipped with various types of sensors in order to detect objects in the surroundings. For example, autonomous vehicles may include sonar, radar, camera, lidar, and other devices that scan, generate and/or record data about the vehicle's surroundings. This data may be combined with pre-stored map information in order to enable the autonomous vehicle to plan trajectories in order to maneuver itself through the surroundings.

Autonomous vehicles may require roadside assistance from time to time, in particular, in situations in which such autonomous vehicles may no longer be able to make forward progress towards a destination of the vehicle. For instance, such vehicles may not have a “driver” who is able to take control of the vehicle and/or address the reason why the vehicle requires human intervention or assistance. As used herein, the phrases “requires human intervention” and “requires assistance” may refer to situations in which a vehicle's computing device or operator decides that the optimal action is to bring the vehicle to a stop despite the ability to continue making forward progress, situations where a hardware or software issue may cause the vehicle to come to a stop, or a combination thereof.

### BRIEF SUMMARY

Aspects of the disclosure provide a method of pre-positioning roadside assistance vehicles within a service area for a fleet of autonomous vehicles. The method includes using, by one or more processors, a clustering approach to determine an assignment identifying a plurality of cluster locations and respective assigned ones of the roadside assistance vehicles. The clustering approach uses a number of clusters corresponding to the number of the roadside assistance vehicles. The method also includes sending, by the one or more processors, distribution information to computing devices associated with technicians of the respective assigned ones of the roadside assistance vehicles, the distribution information enabling the technicians of the respective assigned ones of the roadside assistance vehicles to proceed to respective ones of the plurality of cluster locations in order to pre-position the roadside assistance vehicles to be ready to provide roadside assistance as needed to the autonomous vehicles of the fleet.

In one example, the method also includes periodically determining an updated assignment identifying an updated plurality of cluster locations and respective assigned ones of the roadside assistance vehicles; and sending updated distribution information to the computing devices based on the updated assignments. The updated distribution information enabling the technicians of the respective assigned ones of the roadside assistance vehicles to proceed to respective ones of the updated plurality of cluster locations in order to reposition the roadside assistance vehicles to be ready to provide roadside assistance as needed to the autonomous vehicles of the fleet. In another example, the clustering approach involves initially setting the cluster locations to current locations of the roadside assistance vehicles. In another example, the clustering approach involves determining a score based on distances between each of the autonomous vehicles and a closest one of the cluster locations. In another example, the clustering approach includes: iteratively determining pluralities of cluster locations; scoring the determined pluralities of cluster locations; and selecting one of the determined pluralities of cluster locations based on the scoring, and wherein the cluster locations correspond to the selected one. In this example, the scoring is based on distances between current locations of the autonomous vehicles and respective closest ones of the cluster locations for each of the plurality of cluster locations. In addition, the distances are one of driving distances, Euclidean distances, or Manhattan distances. In addition or alternatively, the method also includes generating a plurality of assignments for the selected one by assigning the roadside assistance vehicles to respective cluster locations of the selected one; scoring, by the one or more processors, each of the plurality of assignments; and selecting, by the one or more processors, one of the plurality of assignments based on the scores, wherein the determined assignment is the selected one of the plurality of assignments. In this example, the scoring for a given one of the assignments is based on distances between current locations of the roadside assistance vehicles and the assigned respective ones of the cluster locations for that given one of the assignments. In addition or alternatively, the scoring involves determining whether a distance between a given one of the roadside assistance vehicles and the clustering location assigned to the given one of the roadside assistance vehicles is greater than a threshold distance. In another example, the roadside assistance vehicles are a first set of roadside assigned to a primary layer, and the method further comprises: using, by the one or more processors, the clustering approach to determine a second assignment identifying a plurality of second cluster locations and respective assigned ones of a second set of roadside assistance vehicles assigned to a secondary layer, wherein the clustering approach uses a number of clusters corresponding to a number of roadside assistance vehicles in the second set; and sending, by the one or more processors, second distribution information to computing devices associated with technicians of the second set of roadside assistance vehicles, the second distribution information enabling the technicians of the second set of roadside assistance vehicles to proceed to respective ones of the plurality of second cluster locations in order to pre-position the roadside assistance of the second set of roadside assistance vehicles to be ready to provide roadside assistance as needed to the autonomous vehicles of the fleet. In this example, the method also includes reassigning a roadside assistance vehicle of the second set of roadside assistance vehicles to the primary layer. In addition or alternatively, the method also includes reassigning a roadside assistance vehicle of the first set of roadside assistance vehicles to the secondary layer. In another example, the distribution information for a particular roadside assistance vehicle includes instructions for display a map and turn-by-turn directions to an area corresponding to the respective one of the plurality of cluster locations for that particular roadside assistance vehicle. In another example, the method also includes assigning one of the roadside assistance vehicles to provide assistance to one of the autonomous vehicles; removing the one of the autonomous vehicles from a set of the autonomous vehicles; and after removing the one of the autonomous vehicles from the set of autonomous vehicles, updating the assignments by determining new cluster locations based on updated locations of any autonomous vehicles remaining in the set of autonomous vehicles.

Another aspect of the disclosure provides a system for pre-positioning roadside assistance vehicles within a service area for a fleet of autonomous vehicles. The system comprising one or more processors configured to use a clustering approach to determine an assignment identifying a plurality of cluster locations and respective assigned ones of the roadside assistance vehicles. The clustering approach uses a number of clusters corresponding to the number of the roadside assistance vehicles. The one or more processors are also configured to send distribution information to computing devices associated with technicians of the respective assigned ones of the roadside assistance vehicles, the distribution information enabling the technicians of the respective assigned ones of the roadside assistance vehicles to proceed to respective ones of the plurality of cluster locations in order to pre-position the roadside assistance vehicles to be ready to provide roadside assistance as needed to the autonomous vehicles of the fleet.

In one example, the one or more processors are further configured to: periodically determine an updated assignment identifying an updated plurality of cluster locations and respective assigned ones of the roadside assistance vehicles based on the updated assignments; and send updated distribution information to the computing devices, the updated distribution information enabling the technicians of the respective assigned ones of the roadside assistance vehicles to proceed to respective ones of the updated plurality of cluster locations in order to reposition the roadside assistance vehicles to be ready to provide roadside assistance as needed to the autonomous vehicles of the fleet. In another example, the clustering approach involves initially setting the cluster locations to current locations of the roadside assistance vehicles. In another example, the roadside assistance vehicles are a first set of roadside assigned to a primary layer. In this example, the one or more processors are further configured to: use the clustering approach to determine a second assignment identifying a plurality of second cluster locations and respective assigned ones of a second set of roadside assistance vehicles assigned to a secondary layer, wherein the clustering approach uses a number of clusters corresponding to a number of roadside assistance vehicles in the second set; and send second distribution information to computing devices associated with technicians of the second set of roadside assistance vehicles, the second distribution information enabling the technicians of the second set of roadside assistance vehicles to proceed to respective ones of the plurality of second cluster locations in order to pre-position the roadside assistance of the second set of roadside assistance vehicles to be ready to provide roadside assistance as needed to the autonomous vehicles of the fleet. In another example, the one or more processors are further configured to: assign one of the roadside assistance vehicles to provide assistance to one of the autonomous vehicles; remove the one of the autonomous vehicles from a set of the autonomous vehicles; and after removing the one of the autonomous vehicles from the set of autonomous vehicles, update the assignments by determining new cluster locations based on updated locations of any autonomous vehicles remaining in the set of autonomous vehicles.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3A-3B are example external views of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example view of map information, autonomous vehicles and roadside assistance vehicles driving in an environment in accordance with aspects of the disclosure.

FIG. 7 is an example view of autonomous vehicles, roadside assistance vehicles, and cluster locations in accordance with aspects of the disclosure.

FIG. 8 is an example view of autonomous vehicles, roadside assistance vehicles, cluster locations, and distances in accordance with aspects of the disclosure.

FIG. 9 is an example view of autonomous vehicles, roadside assistance vehicles, cluster locations, and assignments in accordance with aspects of the disclosure.

FIG. 10 is an example view of autonomous vehicles, roadside assistance vehicles, cluster locations, and distances in accordance with aspects of the disclosure.

FIG. 11 is an example view of map information, autonomous vehicles, roadside assistance vehicles, cluster locations, and snapped cluster locations in accordance with aspects of the disclosure.

FIGS. 12A and 12B are example client computing devices and displayed

information in accordance with aspects of the disclosure.

FIGS. 13A and 13B are example client computing devices and displayed information in accordance with aspects of the disclosure.

FIG. 14 is an example view of autonomous vehicles and roadside assistance vehicles driving in an environment in accordance with aspects of the disclosure.

FIG. 15 is a flow diagram in accordance with aspects of the disclosure.

### DETAILED DESCRIPTION

### Overview

The technology relates to prepositioning roadside assistance vehicles o that the roadside assistance vehicles can be ready to provide roadside assistance to autonomous vehicles as needed as quickly and efficiently as possible. As noted above, autonomous vehicles may require roadside assistance from time to time, in particular in situations in which such vehicles may no longer be able to make forward progress towards a destination of the vehicle. For instance, such vehicles may not have a “driver” who is able to take control of the vehicle and/or address the reason why the vehicle requires assistance. As used herein, the phrases “requires human intervention” and “requires assistance” may refer to situations in which a vehicle's computing device, a driver (if available), or a remote operator decides that the optimal action is to bring the vehicle to a stop despite the ability to continue making forward progress, situations where a hardware or software issue may cause the vehicle to come to a stop, or a combination thereof.

As one instance, the computing devices of a vehicle in the autonomous driving mode may be unable to make forward progress towards its destination. For instance, a vehicle's computing devices may detect a problem that may inhibit forward progress of a vehicle, such as a stationary obstacle blocking a portion of the roadway or low tire pressure which may be caused, for example, due to a puncture in a tire of the vehicle. In response, the computing devices may stop the vehicle immediately in a lane or by pulling the vehicle over depending upon the situation. At this point in time, the vehicle would require assistance. As another instance, if the vehicle's computing devices detect a software or hardware issue with any of the features of the autonomous control system, the vehicle may enter a “fallback state” or a mode of degraded operation. In such instances, the vehicle's computing devices may bring the vehicle to a stop again causing the vehicle to require assistance. As another instance, if the computing devices detect input of a particular force at certain user inputs of the vehicle (e.g. brake pedal, accelerator pedal, steering wheel, pullover button, emergency stopping button etc.), devices may stop the vehicle (e.g. pull the vehicle over or stop immediately), causing the vehicle to require assistance. As another instance, the vehicle's computing devices receive instructions from a remote computing device to stop or pull over. For example, in certain circumstances, a human operator may determine that it is no longer safe or practical for a vehicle to continue operating in an autonomous driving mode. This may occur for any number of reasons, such as if the passenger requests assistance (via a user input of the vehicle and/or his or her mobile phone), etc.

Typical roadside assistance may be provided by first responders or third party providers. However, summoning first responders may be an inappropriate use of such resources when there is no danger to humans or traffic. In addition, third party responders may not be equipped to resolve issues faced by autonomous vehicles and can be cost prohibitive when used for a fleet of autonomous vehicles. Moreover, having one roadside assistance vehicle for each autonomous vehicle of the fleet is not a scalable solution.

Because the number of roadside assistance vehicles is likely to be much less than the number of autonomous vehicles in a fleet of autonomous vehicles, and as such, assigning roadside assistance vehicles to one or a specific set of vehicles may be unrealistic and costly. Other approaches may include a need-based dispatching of roadside assistance vehicles. However, this approach may result in long and unpredictable wait times.

To address these concerns, a system which includes one or more server computing devices may monitor the locations of autonomous vehicles of the fleet of autonomous vehicles as well as the location of roadside assistance vehicles. In this regard, the server computing devices may receive periodic updates identifying location information and status of the autonomous vehicles as well as updates from the roadside assistance vehicles and/or client computing devices (e.g., cell phones) associated with the technicians currently driving the roadside assistance vehicles.

In addition, the one or more server computing devices may track the status of the autonomous vehicles as well as the roadside assistance vehicles. This may include, for example, tracking whether an autonomous vehicle of the fleet is currently providing transportation services (i.e., transporting goods or persons), whether the autonomous vehicle is occupied with a passenger, whether an autonomous vehicle requires roadside assistance, whether the autonomous vehicle has been assigned a roadside assistance vehicle, and so on. Similarly, this may include tracking whether a roadside assistance vehicle is assigned to a geographic area or to provide roadside assistance to a particular autonomous vehicle of the fleet.

In order to determine a distribution of roadside assistance vehicles, the server computing device may utilize a clustering approach. For instance, using the current locations of the autonomous vehicles of the fleet and the number of roadside assistance vehicles, the server computing devices may utilize a clustering approach, to determine an assignment or where to best position the roadside assistance vehicles. In some instances, the current locations of the roadside assistance vehicles may also be input into a k-means clustering algorithm, and the clustering algorithm may provide a list of k number of cluster locations and associated roadside assistance vehicles. In this regard, the output of the k-means clustering may automatically assign each roadside assistance vehicle to one of the cluster locations. Thus, the value of k may correspond to the number of roadside assistance vehicles not currently assigned to providing roadside assistance to an autonomous vehicle.

Using a k-means clustering approach, the clustering may start with cluster locations corresponding to the current locations of the roadside assistance vehicles, clustering the autonomous vehicles of the fleet to these “cluster locations”, and scoring the results. The scoring may be based on a distance between each autonomous vehicle and a center of a closest of the cluster locations. These distances may then be summed to determine an overall score. The cluster locations may then be updated or adjusted. The autonomous vehicles may then be clustered to these updated locations, and the results re-scored. This process may continue until the overall scores and cluster locations stabilize. At this point, the clustering is completed, and the results are a list of cluster locations and corresponding roadside assistance vehicles.

The server computing devices may then send the determined assignment to the client computing devices of the technicians and/or computing devices of the roadside assistance vehicles. This may enable the technicians to drive the roadside assistance vehicles to the assigned locations and thereby preposition the roadside assistance vehicles. The server computing devices may periodically reassign and redistribute the roadside assistance vehicles to new areas. This may effectively “rebalance” the distribution of roadside assistance vehicles every so often, such as every minute or more or less.

In some instances, the server computing devices may determine that an autonomous vehicle of the fleet requires roadside assistance. The server computing devices may then select the roadside assistance vehicle closest in driving time, driving distance, or other distance (e.g., Euclidean or Manhattan). Once a particular roadside assistance vehicle is assigned to provide roadside assistance, the server computing devices may automatically re-cluster without the particular roadside assistance vehicle. Once a technician and/or roadside assistance vehicle is assigned to provide roadside assistance to an autonomous vehicle of the fleet, the server computing devices may provide information to the technician to enable the technician to drive to the location of the autonomous vehicle. In addition, once a roadside assistance vehicle is assigned to an autonomous vehicle, the server computing devices may send additional information for display to any passengers of the vehicle.

The features described herein may provide a more predictable, resilient, scalable, and cost-effective distribution and prepositioning of roadside assistance vehicles. In addition, the model may enable the distribution to be dynamic and adjustable depending upon the number of available roadside assistance vehicles and how likely autonomous vehicles are to require assistance at any given location within a service area. In other words, the features described herein may utilize the locations of all autonomous vehicles of a fleet and provide instructions to all technicians (drivers) of roadside assistance vehicles to drive to certain areas. If the technicians follow those driving instructions, response times for roadside assistance can be globally optimized if a particular autonomous vehicle of the fleet requires assistance. At the same time, the features described herein may allow for a more scalable approach.

### Example Systems

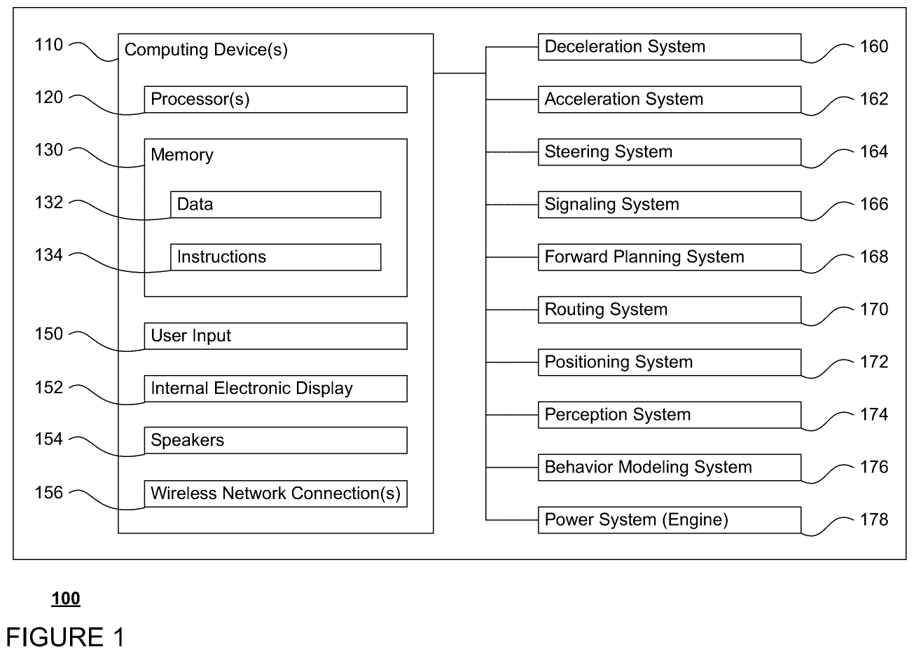

As shown in FIG. 1, an autonomous vehicle 100 in accordance with one aspect of the disclosure includes various components. Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

The U.S. National Highway Traffic Safety Administration (NHTSA) and the Society of Automotive Engineers (SAE) have each identified different levels to indicate how much, or how little, a vehicle controls the driving, although different organizations may categorize the levels differently. Moreover, such classifications may change (e.g., be updated) overtime.

As described herein, in a semi or partially autonomous driving mode, even though the vehicle assists with one or more driving operations (e.g., steering, braking and/or accelerating to perform lane centering, adaptive cruise control or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

In contrast, in a fully autonomous driving mode, the control system of the vehicle performs all driving tasks and monitors the driving environment. This may be limited to certain situations such as operating in a particular service region or under certain time or environmental restrictions, or may encompass driving under all conditions without limitation. In a fully autonomous driving mode, a person is not expected to take over control of any driving operation.

Unless indicated otherwise, the architectures, components, systems and methods described herein can function in a semi or partially autonomous driving mode, or a fully-autonomous driving mode.

While certain aspects of the disclosure are particularly useful in connection with specific types of vehicles, the vehicle may be any type of vehicle including, but not limited to, cars, trucks (e.g. garbage trucks, tractor-trailers, pickup trucks, etc.), motorcycles, buses, recreational vehicles, street cleaning or sweeping vehicles, etc. The vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor 120. The memory 130 may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 120 may be any conventional processors, such as commercially available CPUs or GPUs. Alternatively, the one or more processors may include a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more of a button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, electronic display 152 may be located within a cabin of autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Computing devices 110 may be part of an autonomous control system for the autonomous vehicle 100 and may be capable of communicating with various components of the vehicle in order to control the vehicle in an autonomous driving mode. For example, returning to FIG. 1, computing devices 110 may be in communication with various systems of autonomous vehicle 100, such as deceleration system 160, acceleration system 162, steering system 164, signaling system 166, planning system 168, routing system 170, positioning system 172, perception system 174, behavior modeling system 176, and power system 178 in order to control the movement, speed, etc. of autonomous vehicle 100 in accordance with the instructions 134 of memory 130 in the autonomous driving mode.

As an example, computing devices 110 may interact with deceleration system 160 and acceleration system 162 in order to control the speed of the vehicle. Similarly, steering system 164 may be used by computing devices 110 in order to control the direction of autonomous vehicle 100. For example, if autonomous vehicle 100 is configured for use on a road, such as a car or truck, steering system 164 may include components to control the angle of wheels to turn the vehicle. Computing devices 110 may also use the signaling system 166 in order to signal the vehicle's intent to other drivers or vehicles, for example, by lighting turn signals or brake lights when needed.

Routing system 170 may be used by computing devices 110 in order to generate a route to a destination using map information. Planning system 168 may be used by computing device 110 in order to generate short-term trajectories that allow the vehicle to follow routes generated by the routing system. In this regard, the planning system 168 and/or routing system 166 may store detailed map information, e.g., pre-stored, highly detailed maps identifying a road network including the shape and elevation of roadways, lane lines, intersections, crosswalks, speed limits, traffic signals, buildings, signs, real time traffic information (updated as received from a remote computing device), pullover spots, vegetation, or other such objects and information.

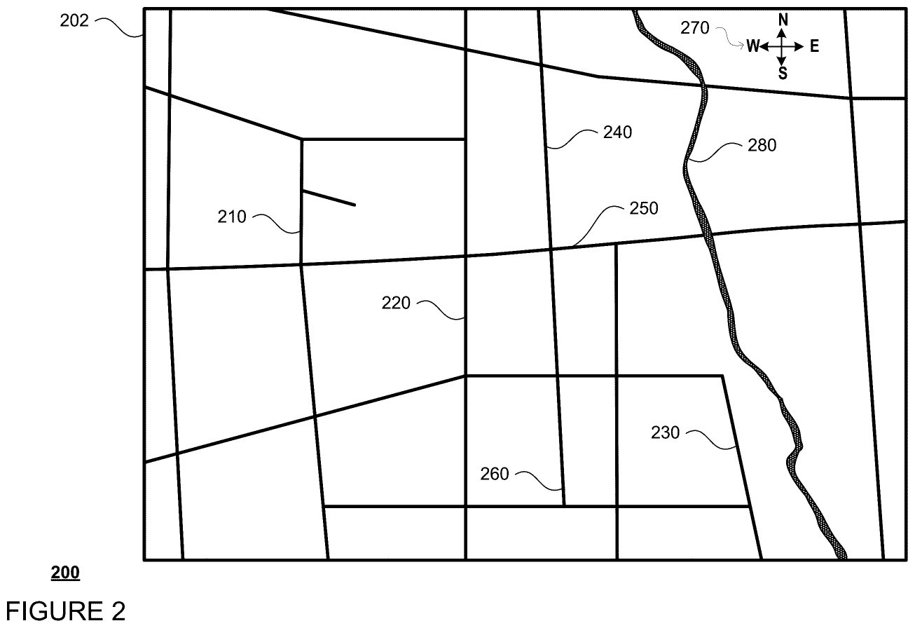

FIG. 2 is an example of a portion of the map information for demonstrative purposes. As shown, the map information 200 includes information identifying the shape, location, and other characteristics of roads and other drivable areas (e.g., parking lots), including roads 210, 220, 230, 240, 250, 260 and others within a geographic area 202. The map information 200 may also include more fine-grained information such as the shape, location and other characteristics of lane markers, lane lines curbs or other road edges which define the shape, location and other characteristics of lanes, traffic control devices such as yield signs, traffic lights, and stop signs, as well as various other features. Such detail is not depicted in the map information 200 for ease of understanding. Compass 270 provides a directional arrow for reference only and need not necessarily be included in the map information as such. However, in addition to these features, the map information may also include information that identifies the direction of traffic and speed limits for each lane or other drivable area as well as information that allows the computing devices 110 to determine whether the vehicle has the right of way to complete a particular maneuver (i.e. complete a turn or cross a lane of traffic or intersection), as well as other features such as buildings, waterways (such as waterway 280), vegetation, signs, etc.

The map information may be configured as a roadgraph. The roadgraph may include a plurality of graph nodes and edges representing features such as crosswalks, traffic lights, road signs, road or lane segments, etc., that together make up the road network of the map information. Each edge is defined by a starting graph node having a specific geographic location (e.g. latitude, longitude, altitude, etc.), an ending graph node having a specific geographic location (e.g. latitude, longitude, altitude, etc.), and a direction. This direction may refer to a direction the autonomous vehicle 100 must be moving in in order to follow the edge (i.e. a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which edges or lanes or other mapped areas are drivable.

The routing system 166 may use the aforementioned map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the vehicle, etc. Each route may include a list of a plurality of nodes and edges which the vehicle can use to reach the destination. Routes may be recomputed periodically as the vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g. because it is faster) and therefore be preferable.

Positioning system 170 may be used by computing devices 110 in order to determine the vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude, a location of a node or edge of the roadgraph as well as relative location information, such as location relative to other cars immediately around it, which can often be determined with less noise than the absolute geographical location.

The positioning system 172 may also include other devices in communication with computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the vehicle such as other road users (vehicles, pedestrians, bicyclists, etc.) obstacles in the roadway, traffic signals, signs, trees, buildings, etc. For example, the perception system 174 may include Lidars, sonar, radar, cameras, microphones and/or any other detection devices that generate and/or record data which may be processed by the computing devices of computing devices 110. In the case where the vehicle is a passenger vehicle such as a minivan or car, the vehicle may include Lidar, cameras, and/or other sensors mounted on or near the roof, fenders, bumpers or other convenient locations.

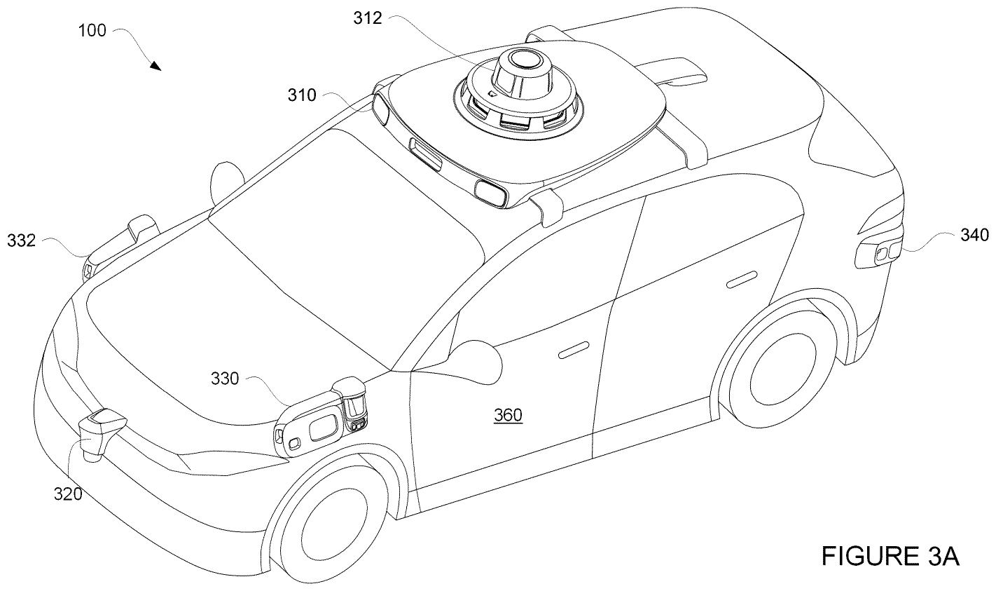

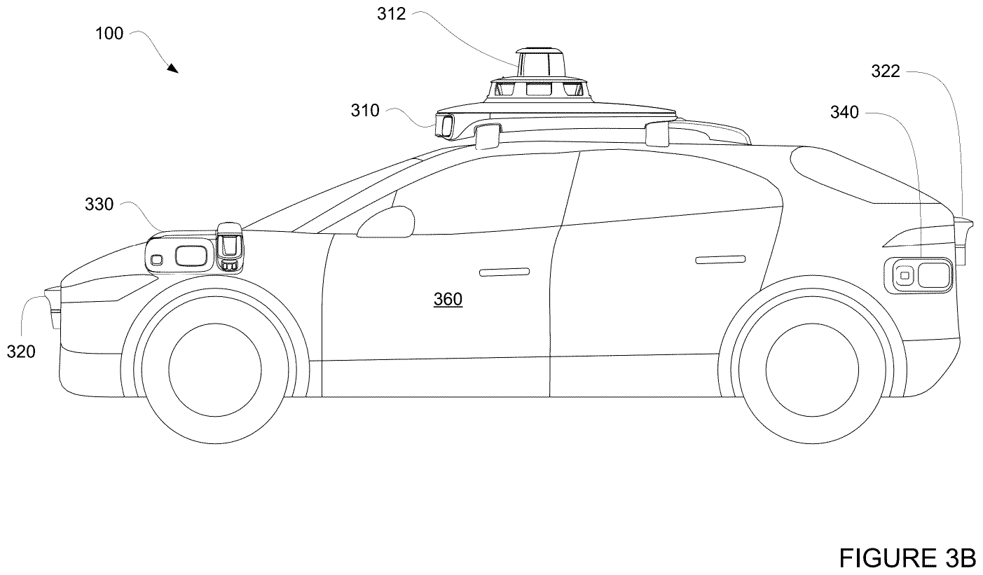

For instance, FIGS. 3A-3B are an example external views of autonomous vehicle 100. In this example, roof-top housing 310 and upper housing 312 may include a LIDAR sensor as well as various cameras and radar units. Upper housing 312 may include any number of different shapes, such as domes, cylinders, “cake-top” shapes, etc. In addition, housing 320, 322 (shown in FIG. 3B) located at the front and rear ends of autonomous vehicle 100 and housings 330, 332 on the driver's and passenger's sides of the vehicle may each store a Lidar sensor and, in some instances, one or more cameras. For example, housing 330 is located in front of driver door 360. Autonomous vehicle 100 also includes a housing 340 for radar units and/or cameras located on the driver's side of the autonomous vehicle 100 proximate to the rear fender and rear bumper of autonomous vehicle 100. Another corresponding housing (not shown may also be arranged at the corresponding location on the passenger's side of the autonomous vehicle 100. Additional radar units and cameras (not shown) may be located at the front and rear ends of autonomous vehicle 100 and/or on other positions along the roof or roof-top housing 310.

Computing devices 110 may be capable of communicating with various components of the vehicle in order to control the movement of autonomous vehicle 100 according to primary vehicle control code of memory of computing devices 110. For example, returning to FIG. 1, computing devices 110 may include various computing devices in communication with various systems of autonomous vehicle 100, such as deceleration system 160, acceleration system 162, steering system 164, signaling system 166, forward planning system 168, routing system 170, positioning system 172, perception system 174, behavior modeling system 176, and power system 178 (i.e. the vehicle's engine or motor) in order to control the movement, speed, etc. of autonomous vehicle 100 in accordance with the instructions 134 of memory 130.

The various systems of the vehicle may function using autonomous vehicle control software in order to determine how to control the vehicle. As an example, a perception system software module of the perception system 174 may use sensor data generated by one or more sensors of an autonomous vehicle, such as cameras, Lidar sensors, radar units, sonar units, etc., to detect and identify objects and their characteristics. These characteristics may include location, type, heading, orientation, speed, acceleration, change in acceleration, size, shape, etc.

In some instances, characteristics may be input into a behavior prediction system software module of the behavior modeling system 176 which uses various behavior models based on object type to output one or more behavior predictions or predicted trajectories for a detected object to follow into the future (e.g. future behavior predictions or predicted future trajectories). In this regard, different models may be used for different types of objects, such as pedestrians, bicyclists, vehicles, etc. The behavior predictions or predicted trajectories may be a list of positions and orientations or headings (e.g. poses) as well as other predicted characteristics such as speed, acceleration or deceleration, rate of change of acceleration or deceleration, etc.

In other instances, the characteristics from the perception system 174 may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may use various models to output a likelihood of a construction zone or an object being an emergency vehicle.

Detected objects, predicted trajectories, various likelihoods from detection system software modules, the map information identifying the vehicle's environment, position information from the positioning system 170 identifying the location and orientation of the vehicle, a destination location or node for the vehicle as well as feedback from various other systems of the vehicle may be input into a planning system software module of the planning system 168. The planning system 168 may use this input to generate planned trajectories for the vehicle to follow for some brief period of time into the future based on a route generated by a routing module of the routing system 170. Each planned trajectory may provide a planned path and other instructions for an autonomous vehicle to follow for some brief period of time into the future, such as 10 seconds or more or less. In this regard, the trajectories may define the specific characteristics of acceleration, deceleration, speed, direction, etc. to allow the vehicle to follow the route towards reaching a destination. A control system software module of computing devices 110 may be configured to control movement of the vehicle, for instance by controlling braking, acceleration and steering of the vehicle, in order to follow a trajectory.

The computing devices 110 may control the vehicle in one or more of the autonomous driving modes by controlling various components. For instance, by way of example, computing devices 110 may navigate the vehicle to a destination location completely autonomously using data from the detailed map information and planning system 168. Computing devices 110 may use the positioning system 170 to determine the vehicle's location and perception system 174 to detect and respond to objects when needed to reach the location safely. Again, in order to do so, computing device 110 and/or planning system 168 may generate trajectories and cause the vehicle to follow these trajectories, for instance, by causing the vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of autonomous vehicle 100 by steering system 164), and signal such changes (e.g., by lighting turn signals) using the signaling system 166. Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

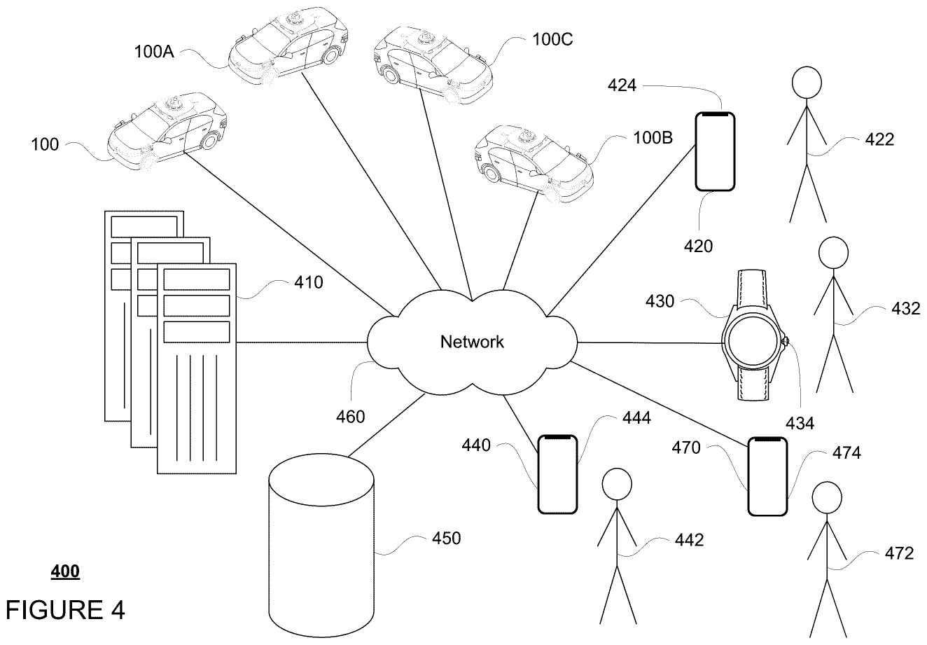

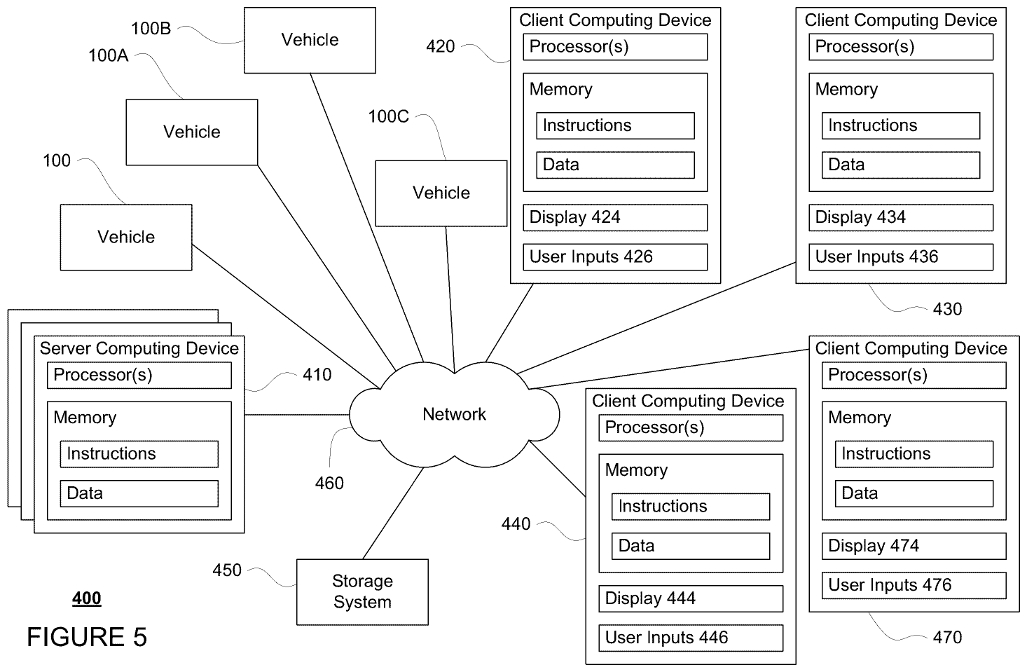

Computing device 110 of autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440, 470 and a storage system 450 connected via a network 460. System 400 also includes autonomous vehicle 100A and autonomous vehicle 100B, which may be configured the same as or similarly to autonomous vehicle 100. Although only a few vehicles and computing devices are depicted for simplicity, a typical system may include significantly more.

As shown in FIG. 5, each of computing devices 410, 420, 430, 440, 470 may include one or more processors, memory, data and instructions. Such processors, memories, data and instructions may be configured similarly to one or more processors 120, memory 130, data 132, and instructions 134 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of autonomous vehicle 100 or a similar computing device of autonomous vehicle 100A, autonomous vehicle 100B or autonomous vehicle 100C as well as computing devices 420, 430, 440, 470 via the network 460. For example, autonomous vehicles 100, 100A, 100B, 100C may be a part of a fleet of vehicles that can be dispatched by server computing devices to various locations.

In this regard, the server computing devices 410 may function as a fleet management system which can be used to track the status of autonomous vehicles of the fleet and arrange trips for passengers by assigning and dispatching vehicles such as autonomous vehicles 100, 100A, 100B, 100C. These assignments may include scheduling trips to different locations in order to pick up and drop off those passengers. In this regard, the server computing devices 410 may operate using scheduling system software in order to manage the aforementioned autonomous vehicle scheduling and dispatching. In addition, the computing devices 410 may use network 460 to transmit and present information to a user, such as user 422, 432, 442, 472 on a display, such as displays 424, 434, 444, 474 of computing devices 420, 430, 440. In this regard, computing devices 420, 430, 440, 470 may be considered client computing devices.

As shown in FIG. 3, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444, 474 (e.g., a monitor having a screen, a touch-screen, a projector, a television, or other device that is operable to display information), and user input devices 426, 436, 446, 476 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing devices 420, 440, 470 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch as shown in FIG. 3. As an example the user may input information using a small keyboard, a keypad, microphone, using visual signals with a camera, or a touch screen.

In some examples, client computing device 420 may be a mobile phone used by a passenger of a vehicle. In other words, user 422 may represent a passenger. In addition, client computing device 430 may represent a smart watch for a passenger of a vehicle. In other words, user 432 may represent a passenger. The client computing devices 440 may represent a client computing device, for example, incorporated into a roadside assistance vehicle or a mobile phone used by a roadside assistance technician who can provide roadside assistance to an autonomous vehicle and/or a passenger. In other words, users 442, 472 may each represent a roadside assistance technician (technician) of a transportation service utilizing the autonomous vehicles 100, 100A, 100B, 100C. Although only a few passengers and technicians are shown in FIGS. 4 and 5, any number of such passengers and technicians (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of computing devices 110, 410, 420, 430, 440, 470 etc. Storage system 450 may store various types of information which may be retrieved or otherwise accessed by a server computing device, such as one or more server computing devices 410, in order to perform some of the features described herein.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

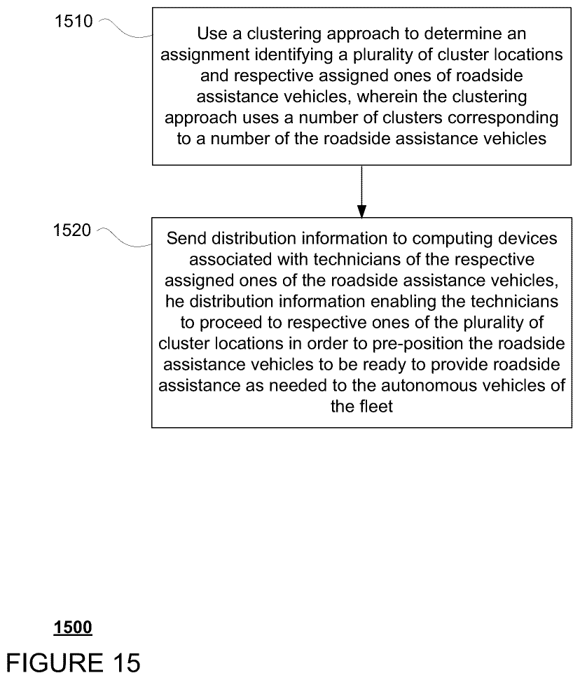

FIG. 15 is an example flow diagram 1500 depicting an example method for enabling distribution or pre-positioning of roadside assistance vehicles within a service area for a fleet of autonomous vehicles, which may be performed by one or more processors, such as the one or more processors of the server computing devices 410. In this example, at block 1510, a clustering approach is used to determine an assignment identifying a plurality of cluster locations and respective assigned ones of roadside assistance vehicles. The clustering approach uses a number of clusters corresponding to the number of the roadside assistance vehicles.

The server computing devices 410 may monitor the locations of autonomous vehicles 100, 100A, 100B, 100C of the fleet of autonomous vehicles as well as the location of roadside assistance vehicles. In this regard, the server computing devices 410 may receive periodic updates identifying location information and status of the autonomous vehicles 100, 100A, 100B as well as updates from the roadside assistance vehicles and/or client computing devices (e.g., cell phones) associated with the technicians currently driving the roadside assistance vehicles. As an example, this information may be sent and received via the network 460.

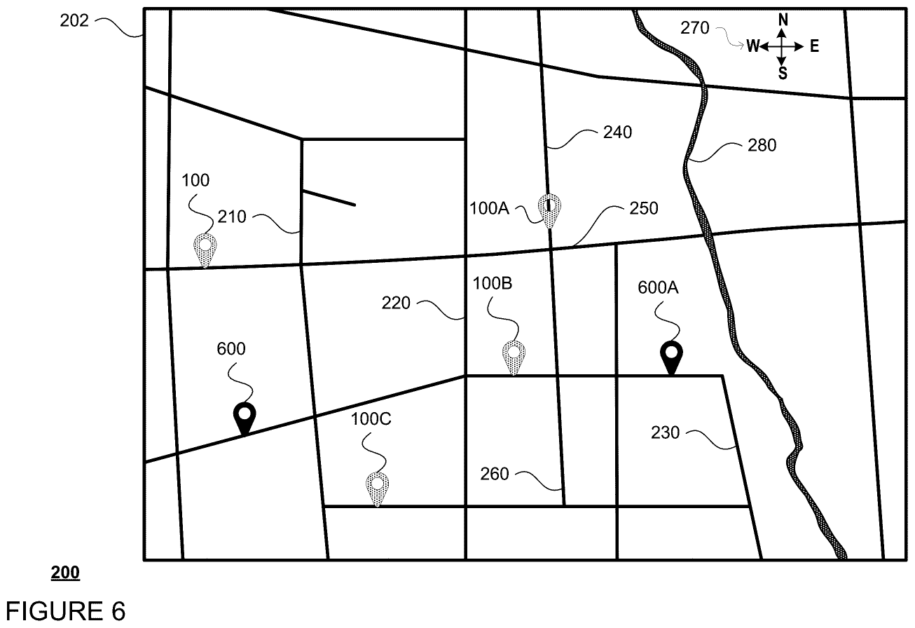

FIG. 6 is an example view of the geographic area 202 and the map information 200. FIG. 6 also depicts map pins identifying the locations of autonomous vehicles 100, 100A, 100B, 100C as well as roadside assistance vehicles 600, 600A. Each of these roadside assistance vehicles 600, 600A includes a human driver and may include an in-vehicle computing device or other client computing device (e.g., client computing devices 440, 470) which may be used to communicate information to the human driver.

The server computing devices 410 may track the status of the autonomous vehicles 100, 100A, 100B, 100C as well as the roadside assistance vehicles 600, 600A. This may include, for example, tracking whether each autonomous vehicle of the fleet is currently providing transportation services (i.e., transporting goods or persons), whether the autonomous vehicle is occupied with a passenger, whether an autonomous vehicle requires roadside assistance, whether the autonomous vehicle has been assigned a roadside assistance vehicle, and so on. Similarly, this may include tracking whether a roadside assistance vehicle is assigned to a geographic area or to provide roadside assistance to a particular autonomous vehicle of the fleet. This information may be stored in a table or other configuration in the storage system 450.

In order to determine a distribution of roadside assistance vehicles, the server computing devices 410 may utilize a clustering approach. For instance, using the current locations of the autonomous vehicles 100, 100A, 100B, 100C and the number of roadside assistance vehicles (here, two), the server computing devices 410 may utilize a clustering approach, to determine an assignment or where to best position the roadside assistance vehicles. In some instances, the current locations of the roadside assistance vehicles 600, 600A may also be input into a k-means clustering algorithm, and the clustering algorithm may provide a list of k number of cluster locations and associated roadside assistance vehicles. In this regard, the output of the k-means clustering may automatically assign each roadside assistance vehicle to one of the cluster locations.

The value of k may correspond to the number of roadside assistance vehicles not currently assigned to providing roadside assistance to an autonomous vehicle. Again, in the example of FIG. 6, two roadside assistance vehicles, so k=2. In this regard, if a technician takes a break or ends a shift, the technician's roadside assistance vehicle can also be disregarded. Similarly, if a roadside assistance vehicle has been assigned to a particular autonomous vehicle or is not currently in service (i.e. is parked at a depot or other location), the location of the particular autonomous vehicle may be excluded from the clustering.

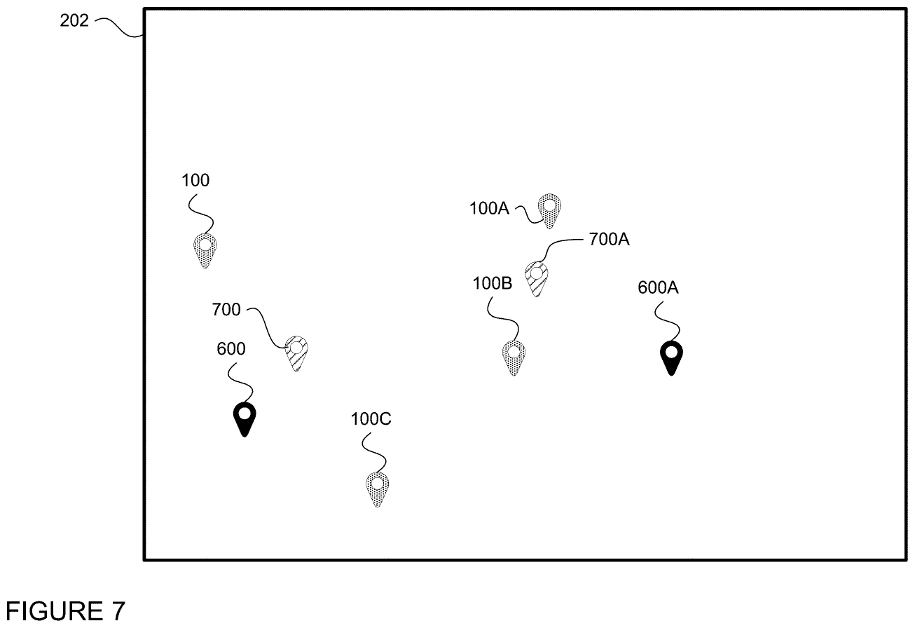

Using a k-means clustering approach, the clustering may start with cluster locations corresponding to the current locations of the roadside assistance vehicles 600, 600A, clustering the autonomous vehicles 100, 100A, 100B, 100C of the fleet to these “cluster locations”, and scoring the results. For demonstration purposes, FIG. 7 depicts example “cluster locations” 700, 700A in the geographic area. The map information 200 is not depicted, as the cluster locations may have been determined without reference to the map information.

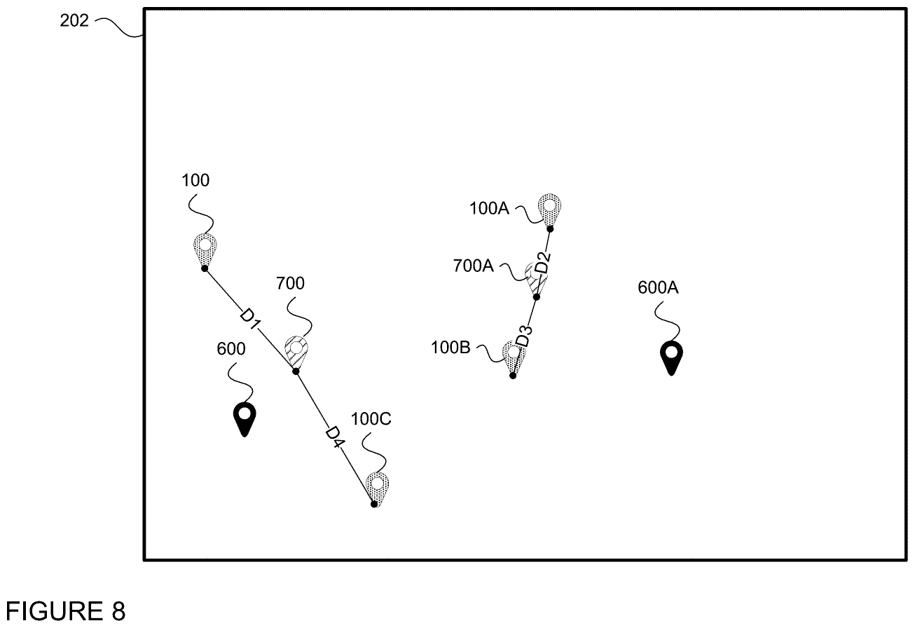

The scoring may be based on a distance (e.g., greater distances result in higher or lower scores) between each autonomous vehicle and a center of a closest of the cluster locations. FIG. 8 represents example of such distances D1, D2, D3, D4 between autonomous vehicles 100, 100A, 100B, 100C, 100D, and the center of the cluster locations 700, 700A.

These distances may then be summed (and in some instances normalized) to determine an overall score. For example, distances D1, D2, D3, and D4 may be summed to determine an overall score in feet, miles, meters, etc. The cluster locations may then be updated or adjusted (e.g., by making small shifts in the locations). The autonomous vehicles 100, 100A, 100B, 100C may then be clustered to these updated locations, and the results re-scored. For instance, the process may involve iteratively and alternatively: (1) assign each autonomous vehicle to the nearest cluster center and (2) update each cluster center to be the mean point of all assigned autonomous vehicles. This may thus reduce the sum of distances in each iteration, and converge to a stable set of cluster centers. This process may continue until the overall scores and cluster locations stabilize. At this point, the clustering is completed, and the results are a list of cluster locations and corresponding roadside assistance vehicles.

The distance between each autonomous vehicle and the center of the closest cluster location may be determined in different ways. For example, one or both of these distances may be a “straight-line”, linear, or Euclidean distance as depicted in FIG. 8 determined independent of driving distances or any actual map information. In addition or alternatively, one or both of these distances may be determined using a routing system, actual map information as well as traffic information (e.g., expected or actual traffic congestion) to determine how long it would take the roadside assistance vehicle to reach the location of the assignment. In addition or alternatively, one or both of these distances may be determined using the Manhattan distance or the distances between the location of the roadside assistance vehicle and the assigned location measured along two axes at right angles (e.g., using an x, y coordinate system).

Alternatively, rather than using the current locations of the roadside assistance vehicles, the k-means clustering may be initiated with random starting locations for the roadside assistance vehicles. In such instances, a plurality of iterations, such as 10,000 or more or less, may be run. The results of the iterations may then be scored or ranked in order to identify an “ideal” set of cluster locations for the roadside assistance vehicles.

As in the example above, the scoring or ranking may be based on the distance (e.g., greater distances result in higher or lower scores or rankings) between each autonomous vehicle and a center of a closest of the cluster locations for that iteration. These distances may then be summed (and in some instances normalized) to determine an overall score. As with the distances described above, these may be “straight-line”, linear, Euclidean, or Manhattan distances determined independent of driving distances or any actual map information or determined a routing system, actual map information as well as traffic information.

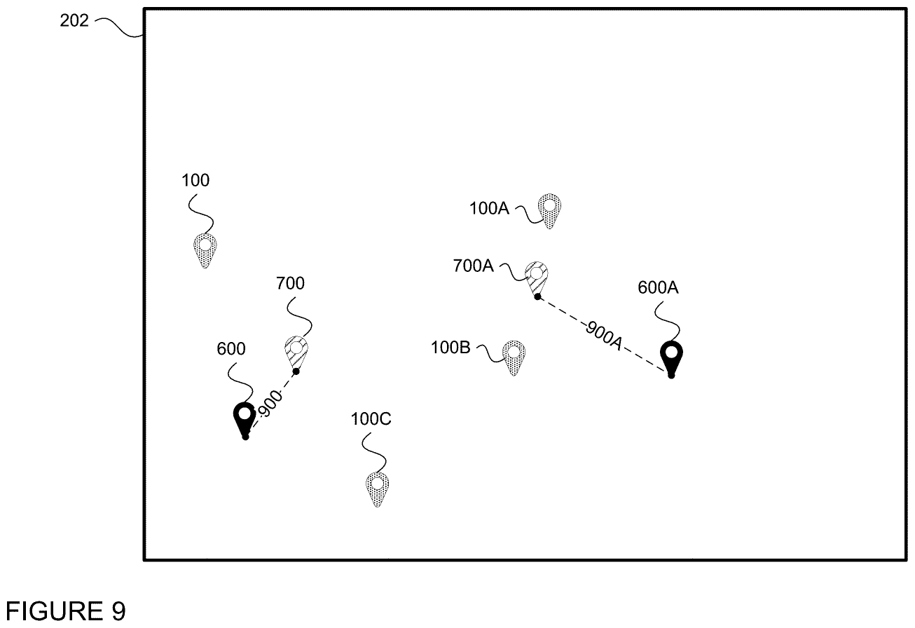

The selected iteration may then be analyzed to determine an assignment or rather, which roadside assistance vehicles should be assigned to which of the cluster locations. For instance, a plurality of different “assignments” may be determined. Each individual assignment may include associating or “assigning” each of the roadside assistance vehicles with one of the cluster locations. In some instances, these assignments may be done randomly or may be based on the distance between each roadside assistance vehicle and each of the cluster locations. FIG. 9 depicts example “assignments” to the cluster locations 700, 700A represented by dashed-line arrows 900, 900A.

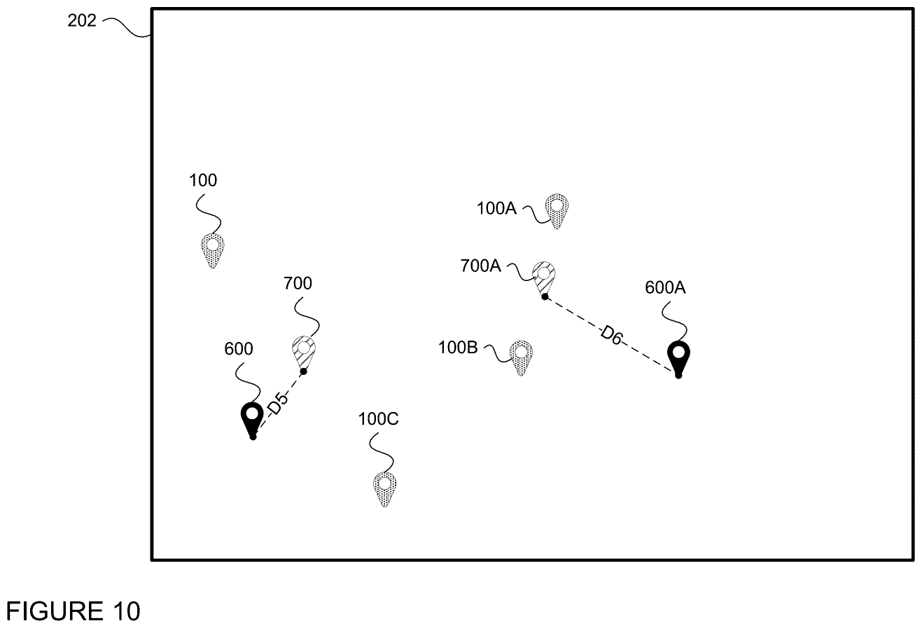

As with the selection of the iterations, the assignments may be scored based on the distances between each roadside assistance vehicle and its respective assigned cluster location. These distances may then be summed (and in some instances normalized) to determine an overall score. As depicted in FIG. 10, each of distances D5 and D6 may be determined and summed together to determine an overall score in feet, miles, meters, etc. The lowest or highest scoring assignment may thus be selected or determined.

In some instances, assignments which result in roadside assistance vehicles “jumping” around too much between different locations may be penalized (e.g., given a higher or lower score or rank). For example, if an assignment requires a roadside assistance vehicle to drive more than 1 minute or 0.25 miles with respect to the map information 200 (e.g., driving miles rather than Euclidean distance), an additional penalty may be added to this score. As an example, an additional 0.25 miles may be added to the sum of D5 plus D6 to get an adjusted overall score. The “best” iteration (e.g., the iteration having the lowest or highest score or ranking) may be selected. As a result, this approach may not always cause the closest vehicle to each cluster location to be assigned to that location.

Returning to FIG. 15, at block 1520, distribution information is sent to computing devices associated with technicians of the respective assigned ones of the roadside assistance vehicles. The distribution information enables the technicians to proceed to respective ones of the plurality of cluster locations in order to pre-position the roadside assistance vehicles to be ready to provide roadside assistance as needed to the autonomous vehicles of the fleet. In other words, the roadside assistance vehicles may be distributed throughout a service area to the cluster locations in order to pre-position these roadside assistance vehicles, and so that the roadside assistance vehicles can be ready to provide roadside assistance as needed as quickly and efficiently as possible. The distribution information may thus enable the technicians of the respective assigned ones of the roadside assistance vehicles to proceed to the cluster locations of the determined assignment.

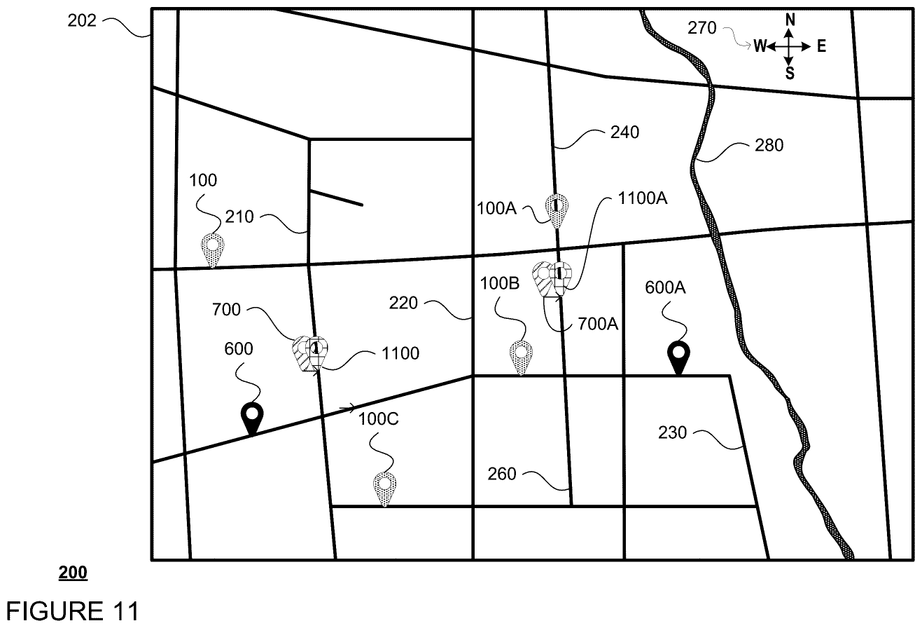

In some instances, the assigned k location may be snapped to a drivable location of the map information (e.g., by moving the k location to a closest drivable location identified in the map information) so that the center of the area is always reachable by the roadside assistance vehicle. For example, as depicted in FIG. 11, each of the cluster locations 700, 700A are “snapped” to the closest road, resulting in new, snapped cluster locations 1100, 1100A.

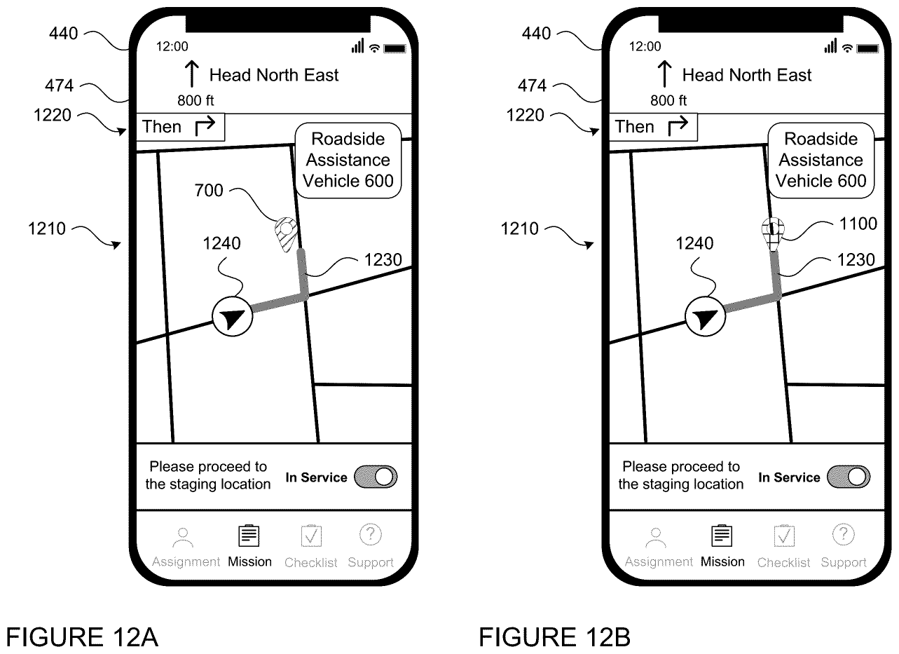

The server computing devices 410 may then send the distribution information including the determined assignment (determined using either of the clustering approaches described above) to the client computing devices of the technicians and/or computing devices of the roadside assistance vehicles. For instance, the server computing devices 410 may send information to the client computing devices 440, 470 identifying the respective assignments of roadside assistance vehicles 600, 600A to the cluster locations 700, 700A (or snapped cluster locations 1100, 1100A if snapped), respectively. FIG. 12A depicts the cluster location 700 on display 474 of the client computing device 440. FIG. 12B depicts the snapped cluster location 1100 on display 474 of the client computing device 440. This may enable the technicians to drive the roadside assistance vehicles to the assigned cluster locations in order to preposition the roadside assistance vehicles. In some instances, the server computing devices 410 may send instructions for displaying additional information such as a map 1210, turn-by-turn directions 1220, an assigned route 1230, and an icon 1240 representative of the roadside assistance vehicle to the assigned location as depicted in FIGS. 12A and 12B.

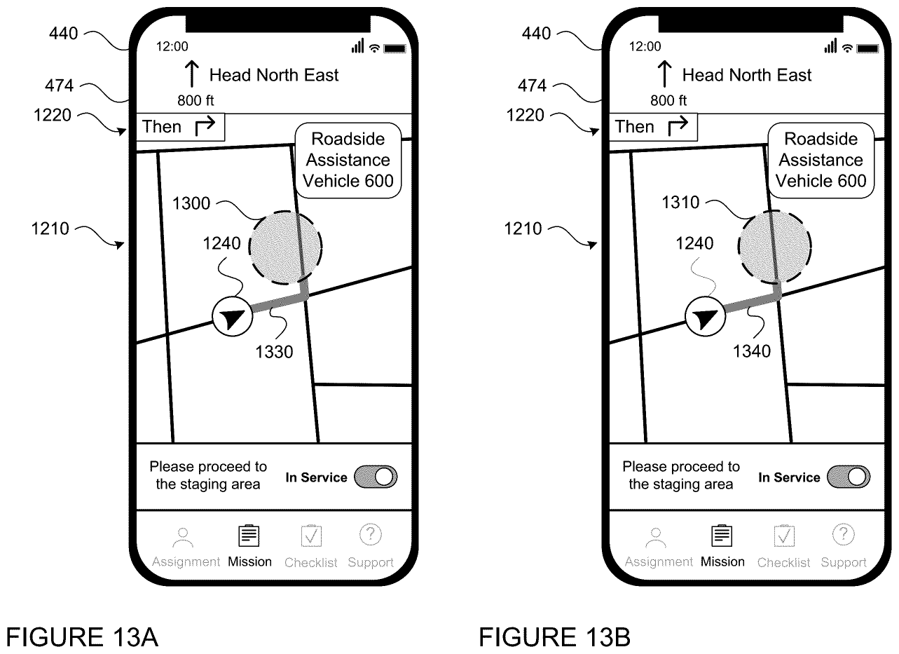

In addition or alternatively, rather than displaying the assigned k location as a point or other specific location on a map, a geographic area, e.g., an area represented by a circle, bubble, or other shape, may be displayed around the assigned location. In this regard, the technician may drive the roadside assistance vehicle into the area. FIG. 13A depicts bubble 1300 on display 474 of client computing device 440. In the example, bubble 1310 is centered around the cluster location 1100. As in the examples of FIGS. 12A and 12B, the server computing devices 410 may send instructions for displaying additional information such as a map 1210, turn-by-turn directions 1220, a route 1330 (which ends at an edge of the bubble 1300), and an icon 1240 representative of the roadside assistance vehicle. As such, each time the server computing devices 410 select a new assignment (e.g., after the next iteration of clustering), the location of the area may be adjusted according to the assigned location of the new assignment.

The size of the area may be fixed, such as X number of meters in radius (e.g. 200, 400, 800, 1000 meters or more or less), but this distance may also be adjusted based on the location on which the area is centered. For example, in a dense urban area where travel short distances may take longer, a smaller radius and/or area may be used so that the roadside assistance vehicle does not get too far away from the clustering point. Conversely, in a suburban area, a larger radius and/or area. Of course, the reverse may also be used depending upon the needs of the transportation system.

As described above, in some instances, the area may be centered around the assigned k location or the assigned k location may be snapped to a drivable location of the map information (e.g., by moving the k location to a closest drivable location identified in the map information) so that the center of the area is always reachable by the roadside assistance vehicle. This may be most useful when the radius of the area is very small. FIG. 13B depicts bubble 1310 on 474 display of client computing device 440. In the example, bubble 1310 is centered around the cluster location 1100. As in the examples of FIGS. 12A and 12B, the server computing devices 410 may send instructions for displaying additional information such as a map 1210, turn-by-turn directions 1220, a route 1340 (which ends at an edge of the bubble 1310), and an icon 1240 representative of the roadside assistance vehicle

In some instances, the technicians may not proceed to the assigned location. As a result, the roadside assistance vehicles may not be pre-positioned at the desired locations within the service area. To address this, a compliance metric that scores how well a technician meets expectations for proceeding to assigned locations may be used. The metric may then be used to display notifications and other information in order to encourage compliance with the assigned locations. For instance, the metric may be used to generate real time alerts. For example, if the location of a roadside assistance vehicle indicates that the technician is not following a route to an assigned location, a notification may be sent by the server computing devices to the technician's client computing device. The notification may indicate to the technician that the technician appears to have left the assigned route and may also instruct the technician how to return to the route or another updated route as needed. This may result in a more effective pre-positioning of the roadside assistance vehicles.

As noted above, server computing devices 410 may periodically reassign and redistribute the roadside assistance vehicles to new areas. In other words, new cluster locations and assignments may be identified or determined as the current locations of the autonomous vehicles 100, 100A, 100B, 100C and roadside assistance vehicles 600, 600A change. This may effectively “rebalance” the distribution of roadside assistance vehicles every so often, such as every minute or more or less.

Although the examples above relate to the current locations of the autonomous vehicles 100, 100A, 100B, 100C, alternatively, a future expected location of each autonomous vehicle 100, 100A, 100B, 100C may be used. This future location may be determined based on the period (e.g., 1 minute into the future) and may be determined based on the current route of each autonomous vehicle of the fleet (which may also be reported periodically to the server computing devices 410).

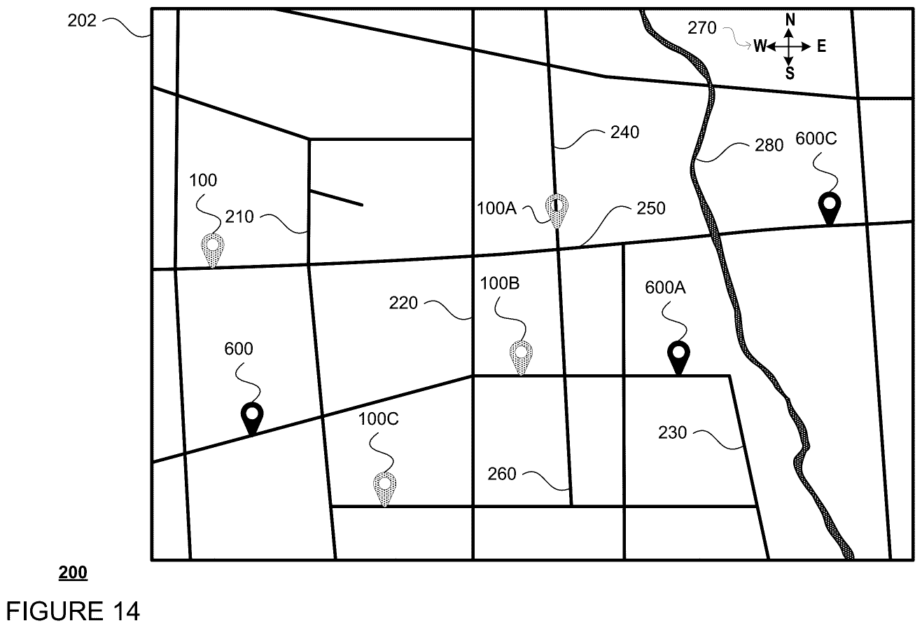

In some instances, certain additional roadside assistance vehicles may be taken into account for the clustering and prepositioning, even if those roadside assistance vehicles are not currently available to provide service. For example, if a technician and roadside assistance vehicle are removed from service, such as roadside assistance vehicle 600A, even though the roadside assistance vehicle is not available to provide roadside assistance services, the nature of the removal may be used to determine whether or not to still include that roadside assistance vehicle. For example, if the technician is taking a brief break (e.g., a mandatory break or a short 5-10 minute break for other purposes where the technician is not expected or available to perform roadside assistance duties), leaving the roadside assistance vehicle 600A out of the clustering may have a significant impact on the clustering once the technician's roadside assistance vehicle is reintroduced into service. As such, roadside assistance vehicle 600A and the location of roadside assistance vehicle 600A may also be taken into account for the clustering. Similarly as shown in FIG. 14, if a new technician and roadside assistance vehicle, such as roadside assistance vehicle 600B which may be configured the same or similarly to the roadside assistance vehicles 600, 600A, are expected to go into service within a short period of time (e.g., 5-10 minutes), the roadside assistance vehicle 600B and the current location of the roadside assistance vehicle 600B may also be taken into account for the clustering.

In some instances, based on their current status, roadside assistance vehicles may be assigned and reassigned to various layers. For instance, a primary layer may include a first set of roadside assistance vehicles that are currently in service and not already assigned to provide roadside assistance. The roadside assistance vehicles assigned to the primary layer may be used in the clustering described above. For example, the roadside assistance vehicles 600, 600A may be assigned to the primary layer for clustering.

A secondary layer may include a second set of roadside assistance vehicles that are currently in service and not already assigned to provide roadside assistance. For example, if the transportation service has a desired ratio of roadside assistance vehicles to autonomous vehicles (e.g., 1:1 or 1:2, etc.), any vehicles beyond this ratio may be assigned to the secondary layer. This desired ratio may be updated (e.g., calculated or adjusted) in real time as needed. For instance, the desired ratio may be adjusted based on the service area, time of day, traffic conditions, number of passengers, the number of the roadside assistance vehicles currently assigned to provide roadside assistance, etc.

The roadside assistance vehicles assigned to this secondary layer may also be clustered and distributed to cluster locations as in the examples described above with respect to the primary layer. However, the clustering and prepositioning of the autonomous vehicles of the secondary layer may be done independently of the clustering and prepositioning of roadside assistance vehicles assigned to the primary layer. In this regard, any “excess” roadside assistance vehicles assigned to this secondary layer can be pre-positioned independent of (e.g. without considering the locations of) any roadside assistance vehicles assigned to the primary layer. For example, if the desired ratio is 1:2, and roadside assistance vehicles 600, 600A are able to provide roadside assistance to autonomous vehicles 100, 100A, 100B, 100C, then the roadside assistance vehicle 600B of FIG. 14, may be considered an “excess” roadside assistance vehicle and may be assigned to the secondary layer.

Still other layers may include all roadside assistance vehicles that are currently on breaks or assigned to provide roadside assistance to a particular autonomous vehicle of the fleet. The secondary or subsequent layers need not include roadside assistance vehicles that are not planning to go back into service within some short period of time or after completing assistance to an autonomous vehicle of the fleet.

As such, when a roadside assistance vehicle assigned to the primary layer is about to go out of service or has gone out of service for a short period of time (e.g., a short break), another roadside assistance vehicle, having a location closest to the given roadside assistance vehicle and which is assigned to the secondary layer may be reassigned to the primary layer and used in the clustering. For example, if the roadside assistance vehicle 600A which is currently assigned to the primary layer, is about to go out of service, then the roadside assistance vehicle 600C may be reassigned from the secondary layer to the primary layer. Thus, the ratio of 1:2 in the example above may be maintained. This may also minimize the impact of such short breaks on the clustering.

In other instances, certain additional roadside assistance vehicles may not be taken into account for the clustering even if those roadside assistance vehicles are currently available to provide service. For instance, if a technician is planning to take a short break within a predetermined period of time (e.g., 10 minutes or more or less), that technician's roadside assistance vehicle and location may be ignored for the clustering. For example, that roadside assistance vehicle can be assigned to the secondary layer until that roadside assistance vehicle goes out of service. However, as the roadside assistance vehicle is assigned to the secondary layer, that roadside assistance vehicle may still be assigned to a nearby autonomous vehicle that requires assistance so long as the roadside assistance vehicle is still in service. For example, using the example above, if the roadside assistance vehicle 600A is about to go out of service, that roadside assistance vehicle may be reassigned from the primary layer to the secondary layer.

In some instances, when a given roadside assistance vehicle initially goes into service (e.g., not after a brief break), the clustering may be performed including this roadside assistance vehicle. However, rather than assigning others of the cluster locations to the other roadside assistance vehicles currently in service, the cluster locations may be recalculated, excluding the given roadside assistance vehicle, and the resulting cluster locations sent to the other roadside assistance vehicles currently in service. For instance, if the roadside assistance vehicles 600, 600A, 600B are currently in service, and the roadside assistance vehicle 600A is about to go out of service (e.g., in a few minutes, the technician is going to take a break or end a shift), the roadside assistance vehicle 600A may be excluded from the clustering, and may not actually receive an assignment (e.g., a cluster location resulting from the clustering). At the same time, the roadside assistance vehicle 600A may still be available to provide roadside assistance to an autonomous vehicle of the fleet if needed. Thus, the clustering may still involve roadside assistance vehicles 600, 600B, each of which may receive an assignment (e.g., a cluster location resulting from the clustering). This may be repeated for a few iterations of clustering. This may also be especially useful in situations in which the given roadside assistance vehicle initially goes into service and is relatively far away from the autonomous vehicles.

Alternatively, when the given roadside assistance vehicle initially goes into service, it may be assigned to the secondary layer to be clustered, etc. with any other roadside assistance vehicles of the secondary layer. Thus, where the desired ratio of in-service roadside assistance vehicles to autonomous vehicles is met, when another roadside assistance vehicle comes into service, this other roadside assistance vehicle may be ignored for the clustering of the roadside assistance vehicles of the primary layer.

In some instances, to improve the prepositioning of roadside assistance vehicles, when a technician of a roadside assistance vehicle is ready to go on a break, the server computing devices 410 may send the client computing device of the technician or of the roadside assistance vehicle a recommendation for one or more nearby locations for the break. This may reduce time the technician needs to spend looking for or finding such a location if not previously known to the technician. In addition, because technicians are likely to choose locations that are close by, this may reduce the likelihood of gaps in the coverage in a service area.

In some instances, the server computing devices 410 may determine that an autonomous vehicle of the fleet requires roadside assistance. The server computing devices 410 may then select the roadside assistance vehicle closest in driving time, driving distance, or other distance (e.g., Euclidean or Manhattan). For instance, roadside assistance vehicles may be selected based on expected time of arrival at the location of the autonomous vehicle that requires assistance. Once a particular roadside assistance vehicle is assigned to provide roadside assistance, the server computing devices 410 may automatically perform the aforementioned clustering and prepositioning steps described above without the particular roadside assistance vehicle. For example, if autonomous vehicle 100 requires roadside assistance, the roadside assistance vehicle 600 may be assigned to provide roadside assistance. At the same time, the roadside assistance vehicle 600 and the location of autonomous vehicle 100 may not be included in the next iteration of the clustering as the roadside assistance vehicle is not currently able to provide roadside assistance to the other autonomous vehicles of the fleet and the location of the autonomous vehicle 100 may inappropriately impact the clustering.

In some instances, the server computing devices 410 may prioritize assignments of roadside assistance vehicles to autonomous vehicles that require assistance based on a priority of a need of that autonomous vehicle. This may consider a number of factors including the type of assistance required, whether the autonomous vehicle is at or near a particular type of region, whether the autonomous vehicle is nearby to a first responder vehicle (e.g., emergency services, police, fire, etc.), whether the autonomous vehicle has been involved in a collision. passenger attributes, etc. For instance, a dirty sensor may be prioritized over a flat tire, as the sensor may be a much quicker fix. Similarly if the autonomous vehicle is located at or near railroad tracks, higher traffic congestion, in an intersection, on a highway, etc. such situations may be prioritized over situations which are not at or near railroad tracks, lower traffic congestion, outside of intersections, on a surface street, etc.

Once a technician and/or roadside assistance vehicle is assigned to provide roadside assistance to an autonomous vehicle of the fleet, the server computing devices 410 may provide information to the technician to enable the technician to drive to the location of the autonomous vehicle. This may involve providing a map and a route including turn-by-turn navigation instructions and in some instances, other information for authenticating the technician to the autonomous vehicle as described above and depicted in FIGS. 12A, 12B, 13A, 13B. In some instances, the technician may also receive information such as contextual information regarding the nature of the assistance needed, such as whether a particular autonomous vehicle has a passenger, needs to be moved to manual driving mode, etc. If the technician is also going to transport the passenger to a particular destination, the technician may also receive information to enable the technician to complete the trip (e.g., turn-by-turn navigation instructions to the particular destination). In addition, to improve security, the technician may need to authenticate with the server computing devices 410 via an application on a client computing device associated with the technician or another client computing device of the roadside assistance vehicle. In addition or alternatively, once the technician has reached the assigned autonomous vehicle, the application may use the aforementioned information authenticating the technician to authenticate with the autonomous vehicle. This may be achieved using known approaches, such as those that involve near field communication or BLUETOOTH or BLUETOOTH LE communication protocols and authentication keys or tokens. Thereafter, the technician may receive information about the status of the autonomous vehicle and/or take actions to control aspects (e.g., lock/unlock doors, change the state, etc.). This may be especially helpful in situations in which the client computing devices are unable to communicate directly with the server computing devices 410 (e.g., there is no service or a service interruption).

In addition, once a roadside assistance vehicle is assigned to an autonomous vehicle, the server computing devices 410 may send additional information for display to any passengers of the autonomous vehicle. For instance, may send the additional information to a client computing device associated with the passenger and/or the autonomous vehicle. Thus, information about the status of the roadside assistance vehicle (e.g., en route, arrived, an estimated time of arrival at the autonomous vehicle, etc.) may be displayed to the passenger on the passenger's client computing device and/or the autonomous vehicle. This may also include requests for information (e.g., “do you see the vehicle?”) from the passenger as well as instructions (e.g., “please stay inside the vehicle”).

Although the examples described herein relate to roadside assistance vehicles generally, such vehicles may include cars, vans, trucks, or other non-traditional roadside assistance vehicles such as scooters or bicycles. In some instances, scooters or bicycles may be distributed differently than (e.g., separately from) other types of roadside assistance vehicles such as cars or vans. For instance, if the roadside assistance vehicle is a scooter, it could not be assigned to a cluster location that is outside of the scooter's effective operational range. In other words, a scooter could not be pre-positioned too far from its current location or too far from a location where the technician is able to access and retrieve supplies, etc.

The features described herein may provide a more predictable, resilient, scalable, and cost-effective distribution of roadside assistance vehicles. In addition, the model may enable the distribution to be dynamic and adjustable depending upon the number of available roadside assistance vehicles and how likely autonomous vehicles 100, 100A, 100B, 100C are to require assistance at any given location within a service area. In other words, the features described herein may utilize the locations of all autonomous vehicles and provide instructions to all technicians (drivers) of roadside assistance vehicles to drive to certain areas. If the technicians follow those driving instructions, response times for roadside assistance can be globally optimized if a particular autonomous vehicle of the fleet requires assistance. At the same time, the features described herein may allow for a more scalable approach.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method of pre-positioning roadside assistance vehicles within a service area for a fleet of autonomous vehicles, the method comprising:
using, by one or more processors, a clustering approach to determine an assignment identifying a plurality of cluster locations and respective assigned ones of the roadside assistance vehicles, wherein the clustering approach uses a number of clusters corresponding to the number of the roadside assistance vehicles; and
sending, by the one or more processors, distribution information to computing devices associated with technicians of the respective assigned ones of the roadside assistance vehicles, the distribution information enabling the technicians of the respective assigned ones of the roadside assistance vehicles to proceed to respective ones of the plurality of cluster locations in order to pre-position the roadside assistance vehicles to be ready to provide roadside assistance as needed to the autonomous vehicles of the fleet.

2. The method of claim 1, further comprising:
periodically determining an updated assignment identifying an updated plurality of cluster locations and respective assigned ones of the roadside assistance vehicles; and
sending updated distribution information to the computing devices based on the updated assignments, the updated distribution information enabling the technicians of the respective assigned ones of the roadside assistance vehicles to proceed to respective ones of the updated plurality of cluster locations in order to reposition the roadside assistance vehicles to be ready to provide roadside assistance as needed to the autonomous vehicles of the fleet.

3. The method of claim 1, wherein the clustering approach involves initially setting the cluster locations to current locations of the roadside assistance vehicles.

4. The method of claim 1, wherein the clustering approach involves determining a score based on distances between each of the autonomous vehicles and a closest one of the cluster locations.

5. The method of claim 1, wherein the clustering approach includes:
iteratively determining pluralities of cluster locations;
scoring the determined pluralities of cluster locations; and
selecting one of the determined pluralities of cluster locations based on the scoring, and wherein the cluster locations correspond to the selected one.

6. The method of claim 5, wherein the scoring is based on distances between current locations of the autonomous vehicles and respective closest ones of the cluster locations for each of the plurality of cluster locations.

7. The method of claim 6, wherein the distances are one of driving distances, Euclidean distances, or Manhattan distances.

8. The method of claim 5, further comprising:
generating a plurality of assignments for the selected one by assigning the roadside assistance vehicles to respective cluster locations of the selected one;
scoring, by the one or more processors, each of the plurality of assignments; and
selecting, by the one or more processors, one of the plurality of assignments based on the scores, wherein the determined assignment is the selected one of the plurality of assignments.

9. The method of claim 8, wherein the scoring for a given one of the assignments is based on distances between current locations of the roadside assistance vehicles and the assigned respective ones of the cluster locations for that given one of the assignments.

10. The method of claim 9, wherein the scoring involves determining whether a distance between a given one of the roadside assistance vehicles and the clustering location assigned to the given one of the roadside assistance vehicles is greater than a threshold distance.

11. The method of claim 1, wherein the roadside assistance vehicles are a first set of roadside assigned to a primary layer, and wherein the method further comprises:
using, by the one or more processors, the clustering approach to determine a second assignment identifying a plurality of second cluster locations and respective assigned ones of a second set of roadside assistance vehicles assigned to a secondary layer, wherein the clustering approach uses a number of clusters corresponding to a number of roadside assistance vehicles in the second set; and
sending, by the one or more processors, second distribution information to computing devices associated with technicians of the second set of roadside assistance vehicles, the second distribution information enabling the technicians of the second set of roadside assistance vehicles to proceed to respective ones of the plurality of second cluster locations in order to pre-position the roadside assistance of the second set of roadside assistance vehicles to be ready to provide roadside assistance as needed to the autonomous vehicles of the fleet.

12. The method of claim 11, further comprising, reassigning a roadside assistance vehicle of the second set of roadside assistance vehicles to the primary layer.

13. The method of claim 11, further comprising, reassigning a roadside assistance vehicle of the first set of roadside assistance vehicles to the secondary layer.

14. The method of claim 1, wherein the distribution information for a particular roadside assistance vehicle includes instructions for display a map and turn-by-turn directions to an area corresponding to the respective one of the plurality of cluster locations for that particular roadside assistance vehicle.

15. The method of claim 1, further comprising:
assigning one of the roadside assistance vehicles to provide assistance to one of the autonomous vehicles;
removing the one of the autonomous vehicles from a set of the autonomous vehicles; and
after removing the one of the autonomous vehicles from the set of autonomous vehicles, updating the assignments by determining new cluster locations based on updated locations of any autonomous vehicles remaining in the set of autonomous vehicles.

16. A system for pre-positioning roadside assistance vehicles within a service area for a fleet of autonomous vehicles, the system comprising one or more processors configured to:
use a clustering approach to determine an assignment identifying a plurality of cluster locations and respective assigned ones of the roadside assistance vehicles, wherein the clustering approach uses a number of clusters corresponding to the number of the roadside assistance vehicles; and
send distribution information to computing devices associated with technicians of the respective assigned ones of the roadside assistance vehicles, the distribution information enabling the technicians of the respective assigned ones of the roadside assistance vehicles to proceed to respective ones of the plurality of cluster locations in order to pre-position the roadside assistance vehicles to be ready to provide roadside assistance as needed to the autonomous vehicles of the fleet.

17. The system of claim 16, wherein the one or more processors are further configured to:
periodically determine an updated assignment identifying an updated plurality of cluster locations and respective assigned ones of the roadside assistance vehicles based on the updated assignments; and
send updated distribution information to the computing devices, the updated distribution information enabling the technicians of the respective assigned ones of the roadside assistance vehicles to proceed to respective ones of the updated plurality of cluster locations in order to reposition the roadside assistance vehicles to be ready to provide roadside assistance as needed to the autonomous vehicles of the fleet.

18. The system of claim 16, wherein the clustering approach involves initially setting the cluster locations to current locations of the roadside assistance vehicles.

19. The system of claim 16, wherein the roadside assistance vehicles are a first set of roadside assigned to a primary layer, and wherein the one or more processors are further configured to:
use the clustering approach to determine a second assignment identifying a plurality of second cluster locations and respective assigned ones of a second set of roadside assistance vehicles assigned to a secondary layer, wherein the clustering approach uses a number of clusters corresponding to a number of roadside assistance vehicles in the second set; and
send second distribution information to computing devices associated with technicians of the second set of roadside assistance vehicles, the second distribution information enabling the technicians of the second set of roadside assistance vehicles to proceed to respective ones of the plurality of second cluster locations in order to pre-position the roadside assistance of the second set of roadside assistance vehicles to be ready to provide roadside assistance as needed to the autonomous vehicles of the fleet.

20. The system of claim 16, wherein the one or more processors are further configured to:
assign one of the roadside assistance vehicles to provide assistance to one of the autonomous vehicles;
remove the one of the autonomous vehicles from a set of the autonomous vehicles; and
after removing the one of the autonomous vehicles from the set of autonomous vehicles, update the assignments by determining new cluster locations based on updated locations of any autonomous vehicles remaining in the set of autonomous vehicles.
